(19) United States
(12) Patent Application Publication
(10) Pub. No.: US 2022/0287014 A1
(43) Pub. Date: Sep. 8, 2022

(54) RESOURCE ALLOCATION METHODS AND APPARATUSES, MESSAGE FRAME PROCESSING METHODS, APPARATUSES AND STORAGE MEDIUMS

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 17/628,373

(22) PCT Filed: Jul. 19, 2019
(86) PCT No.: PCT/CN2019/096916

§ 371 Date: Jan. 19, 2022

(51) Int. Cl. H04W 72/04; H04W 76/10

(52) U.S. Cl. CPC H04W 72/044; H04W 72/0406; H04W 76/10

(57) ABSTRACT

A method for resource allocation. The method includes generating a communication resource allocation message frame; wherein the communication resource allocation message frame includes a frequency band and sector identifier domain, and the frequency band and sector identifier domain indicates a communication frequency band and a transmission direction sector for an antenna; sending the communication resource allocation message frame.

### REFERENCE TO RELATED APPLICATION

This application is a National Stage of International Application No. PCT/CN2019/096916, filed on Jul. 19, 2019, the contents of all of which are incorporated herein by reference in their entirety.

### TECHNICAL FIELD

The present disclosure relates to communication technologies, and in particular to resource allocation methods and apparatuses, message frame processing methods and apparatuses and computer storage mediums.

### BACKGROUND

Multiple-Input Multiple-Output (MIMO) technology is introduced in a Wireless Local Area Network (WLAN) standard (Wi-Fi standard for short) based on Institute of Electrical and Electronics Engineers (IEEE) 802.11 standard, so as to increase an effective utilization rate of frequency spectrum. In the related arts, devices are adopting a MIMO communication mechanism that relies on a single frequency band spectrum. However, under the existing MIMO communication mechanism, communication efficiency and throughput are usually low and can be unsatisfactory in many use cases.

### SUMMARY

The present disclosure provides resource allocation methods and apparatuses, message frame processing methods and apparatuses and computer storage mediums.

According to a first aspect of the present disclosure, there is provided a resource allocation method, including:

generating a communication resource allocation message frame; wherein the communication resource allocation message frame includes a frequency band and sector identifier domain, and the frequency band and sector identifier domain indicates a communication frequency band and a transmission direction of an antenna; and sending the communication resource allocation message frame.

In the above solution, the frequency band and sector identifier domain includes:

a first field indicating the communication frequency band;

a second field indicating the transmission directions of the antenna.

In the above solution, when the second field is assigned a first class parameter value, the second field indicates that the transmission direction of the antenna is omnidirectional, i.e., transmission occurs in all azimuthal directions; when the second field is assigned with a second class parameter value, the second field indicates the transmission occurs in fewer than all azimuthal directions, i.e., in a sector, and indicates the particular sector for the transmissions.

In the above solution, the communication resource allocation message frame further includes a Frame Control (FC) domain, and a third field in the FC domain carries duration information of frequency band occupation.

In the above solution, the method further includes:

if clock frequencies between devices in multiple frequency bands are synchronous, determining a length of the third field as: a sum of a signaling length, a signaling response length, a length of data sent by one of the multiple frequency bands, a length of data confirmation reply and a length of N short inter-frame spaces (SIFS), wherein N is a positive integer equal to or greater than 3.

In the above solution, the method further includes:

if the clock frequencies between devices in multiple frequency bands are asynchronous, determining the length of the third field as: a sum of a signaling length, a signaling response length, a length of data sent by a corresponding frequency band, a length of data confirmation reply and a length of N SIFSs, wherein N is a positive integer equal to or greater than 3.

According to a second aspect of the present disclosure, there is provided a message frame processing method, including:

receiving a communication resource allocation message frame;

determining a communication frequency band and a transmission direction of an antenna based on a frequency band and sector identifier domain comprising the communication resource allocation message frame.

In the above solution, the method further includes:

based on the communication frequency band and the transmission direction, establishing a wireless communication link with a sender device of the communication resource allocation message frame.

In the above solution, the communication resource allocation message frame further includes a Frame Control (FC) domain and a third field in the FC domain carries duration information of frequency band occupation; wherein the method further includes:

based on the third field in the FC domain included in the communication resource allocation message frame, determining an occupation duration of each frequency band.

In the above solution, establishing the wireless communication link with the sender device of the communication resource allocation message frame based on the communication frequency band and the transmission direction includes:

establishing the wireless communication link with the sender device of the communication resource allocation message frame according to the occupation duration of each frequency band and the transmission direction.

According to a third aspect of the present disclosure, there is provided a resource allocation apparatus, including:

a generating unit, configured to generate a communication resource allocation message frame; wherein the communication resource allocation message frame comprises a frequency band and sector identifier domain and the frequency band and sector identifier domain indicates a communication frequency band and a transmission direction of an antenna;

a sending unit, configured to send the communication resource allocation message frame.

In the above solution, the frequency band and sector identifier domain includes:

a first field indicating the communication frequency band;

a second field indicating the transmission direction of the antenna.

In the above solution, when the second field is assigned a first class parameter value, the second field indicates that the transmission direction of the antenna is omnidirectional; when the second field is assigned a second class parameter value, the second field indicates that the azimuthal transmission direction of the antenna corresponds to a sector and indicates the sector.

In the above solution, the communication resource allocation message frame further includes a FC domain, and a third field in the FC domain carries duration information of frequency band occupation;

the generating unit is further configured to determine a length of the third field.

In the above solution, the generating unit is further configured to:

if clock frequencies between devices in multiple frequency bands are synchronous, determine the length of the third field as: a sum of a signaling length, a signaling response length, a length of data sent by one of the multiple frequency bands, a length of data confirmation reply and a length of N short inter-frame spaces (SIFS), wherein N is a positive integer equal to or greater than 3.

In the above solution, the generating unit is further configured to:

if the clock frequencies between devices in multiple frequency bands are asynchronous, determine the length of the third field as: a sum of a signaling length, a signaling response length, a length of data sent via a corresponding frequency band, a length of data confirmation reply and a length of N SIFSs, wherein N is a positive integer equal to or greater than 3.

According to a fourth aspect of the present disclosure, there is provided a message frame processing apparatus, including:

a receiving unit, configured to receive a communication resource allocation message frame;

a determining unit, configured to determine a communication frequency band and a transmission direction of an antenna based on a frequency band and sector identifier domain included in the communication resource allocation message frame.

In the above solution, the apparatus further includes:

a processing unit, configured to:

based on the communication frequency band and the transmission direction, establish a wireless communication link with a sender device of the communication resource allocation message frame.

In the above solution, the communication resource allocation message frame further includes a FC domain, and a third field in the FC domain carries duration information of frequency band occupation.

The determining unit is further configured to:

based on the third field in the FC domain included in the communication resource allocation message frame, determine an occupation duration of each frequency band.

In the above solution, the processing unit is further configured to:

establish the wireless communication link with the sender device of the communication resource allocation message frame according to the occupation duration of each frequency band and the transmission direction.

According to a fifth aspect of the present disclosure, there is provided a resource allocation apparatus, including:

a processor;

a memory storing instructions executable by the processor;

wherein the processor is configured to execute the executable instructions to implement the resource allocation method according to any one technical solution applied to the sender device side.

According to a sixth aspect of the present disclosure, there is provided a message frame processing apparatus, including:

a processor;

a memory storing instructions executable by the processor;

wherein the processor is configured to execute the executable instructions to implement the message frame processing method according to any one technical solution applied to the receiver device side.

According to a seventh aspect of the present disclosure, there is provided a computer storage medium, storing executable instructions, wherein the executable instructions are executed by a processor to implement the resource allocation method according to any one technical solution applied to the sender device side.

According to an eighth aspect of the present disclosure, there is provided a computer storage medium, storing executable instructions, wherein the executable instructions are executed by a processor to implement the message frame processing method according to any one technical solution applied to the receiver device side.

It should be understood that the above general descriptions and subsequent detailed descriptions are merely illustrative and explanatory rather than limiting of the scope of the present disclosure.

### BRIEF DESCRIPTION OF THE DRAWINGS

The accompanying drawings, which are incorporated in and constitute a part of the present description, illustrate examples consistent with the scope of the present disclosure and together with the description, serve to explain the principles of the present disclosure.

FIG. 1 is a structural schematic diagram illustrating a wireless communication system according to an embodiment of the present disclosure;

FIG. 2 is a flowchart illustrating a resource allocation method according to an embodiment of the present disclosure;

FIG. 3 is a schematic diagram illustrating a format of a communication resource allocation message frame according to an embodiment of the present disclosure;

FIG. 4 is a flowchart illustrating a message frame processing method according to an embodiment of the present disclosure;

FIG. 5 is a structural schematic diagram illustrating a composition of a resource allocation apparatus according to an embodiment of the present disclosure;

FIG. 6 is a structural schematic diagram illustrating a composition of a message frame processing apparatus according to an embodiment of the present disclosure;

FIG. 7 is a block diagram illustrating a message frame processing apparatus 800 according to an embodiment of the present disclosure; and

FIG. 8 is a block diagram illustrating a resource allocation apparatus 900 according to an embodiment of the present disclosure.

### DETAILED DESCRIPTION OF THE EMBODIMENTS

Embodiments will be described in detail herein, with the illustrations thereof represented in the drawings. When the following descriptions involve the drawings, similar reference number in different drawings refer to like or similar elements unless otherwise indicated. The embodiments described in the following examples do not represent all possible embodiments within the scope of the present disclosure. Rather, they are merely examples of apparatuses and methods consistent with the scope of the present disclosure as detailed in the appended claims.

The terms used in the present disclosure are for the purpose of describing particular examples only, and are not intended to limit the present disclosure. Terms determined by “a”, “the” and “said” in their singular forms in the present disclosure and the appended claims are also intended to include plurality, unless clearly indicated otherwise in the context. It should also be understood that the term “and/or” as used herein refers to and includes any and all possible combinations of one or more of the associated listed items.

It is to be understood that, although the terms “first,” “second,” “third,” and the like may be used in the present disclosure to describe various information, such information should not be limited to these terms. These terms are only used to distinguish one category of information from another. For example, without departing from the scope of the present disclosure, first information may be referred as second information; and similarly, the second information may also be referred as the first information. Depending on the context, the term “if” as used herein may be interpreted as “when” or “upon” or “in response to determining”.

FIG. 1 is a structural schematic diagram illustrating a wireless communication system according to an embodiment of the present disclosure. As shown in FIG. 1, the wireless communication system is a communication system based on cellular mobile communication technology. The wireless communication system may include several terminals 11 and several base stations 12.

The terminal 11 may be a device directed toward a user to provide voice and/or data connectivity. The terminal 11 may communicate with one or more core networks through a radio access network (RAN). The terminal 11 may be a terminal of an internet of things (IoT), such as a sensor device, a mobile phone, (or called cellular phone), and could be a computer serving as a terminal of an internet of things, and may comprise a fixed, portable, pocket-sized, handheld, or computer-inbuilt or vehicle-mounted apparatus, such as station (STA), subscriber unit, subscriber station, mobile station, mobile, remote station, access point, remote terminal, access terminal, user terminal, user agent, user device, or user equipment. Optionally, the terminal 11 may also comprise an unmanned aerial vehicle (UAV), or a vehicle-mounted device, which for example, may be a trip computer having wireless communication function, or a wireless communication device externally connected to a trip computer. Optionally, the terminal 11 may be a roadside device, for example, it may be a road lamp, signal lamp or other roadside devices having wireless communication capability.

The base station 12 may be a network side device in a wireless communication system. The wireless communication system may be a fourth-generation mobile communication technology (4G) system, which is also called Long Term Evolution (LTE) system. Optionally, the wireless communication system may also be a 5G system, which is also called new radio (NR) system or 5G NR system. Optionally, the wireless communication system may also be a next generation system of a 5G system. An access network in a 5G system may be referred to as New Generation-Radio Access Network (NG-RAN). Optionally, the wireless communication system may also be a Machine-Type Communication (MTC) system.

The base station 12 may be an evolved base station (eNB) employed in a 4G system. Optionally, the base station 12 may also be a base station adopting centralized distributed architecture (gNB) in a 5G system. When adopting the centralized distributed architecture, the base station 12 usually includes a central unit (CU) and at least two distributed units (DU). In the central unit, protocol stacks of a Packet Data Convergence Protocol (PDCP) layer, a Radio Link Control (RLC) layer and a Media Access Control (MAC) layer are disposed; in the distributed unit, a physical (PHY) layer protocol stack is disposed. The implementations of the base station 12 are not limited to the specific embodiments described in the present disclosure. A person of ordinary skill, upon reading the present disclosure will appreciate a wide range of embodiments would fall within the scope of the present disclosure.

Wireless connection may be established between the base station 12 and the terminal 11 through wireless radio. In different implementations, the wireless radio is a wireless radio based on a fourth generation mobile communication network technology (4G) standard; or, the wireless radio is a wireless radio based on a fifth generation mobile communication network technology (5G) standard, for example, the wireless radio is a new radio; or, the wireless radio may also be a wireless radio based on a next generation mobile communication network technology standard of 5G.

In some embodiments, end to end (E2E) connections may also be established between the terminals 11, for example, in the scenarios of vehicle to vehicle (V2V) communication in vehicle to everything (V2X) communication, vehicle to Infrastructure (V2I) communication, and vehicle to pedestrian (V2P) communication and the like.

In some embodiments, the above wireless communication system may further include a network management device 13.

Several base stations 12 are connected to the network management device 13 respectively. The network management device 13 may be a core network device in the wireless communication system, for example, the network management device 13 may be a Mobility Management Entity (MME) in an Evolved Packet Core (EPC). Alternatively, the network management device may also be another core network device, such as Serving GateWay (SGW), Public Data Network GateWay (PGW), Policy and Charging Rules Function (PCRF), or Home Subscriber Server (HSS). The implementation morphology of the network management device 13 is not limited in the embodiments of the present disclosure.

In the related arts, the wireless network standard (IEEE802.11) establishes a study group (SG) to research a next generation WLAN standard (IEEE802.11be), which requires high rate, low delay and large throughput. Its target application scenarios include but are not limited to video transmission, Augmented Reality (AR) transmission, Virtual Reality (VR) transmission and the like.

In the related arts, MIMO technology is introduced in the Wi-Fi standard to improve the effective utilization rate of frequency spectrum, and the devices adopt the MIMO communication mechanism only under a single frequency band spectrum. However, under that MIMO communication mechanism, communication efficiency and throughput are usually low.

For IEEE802.11be, one device may perform communication under multiple frequency bands at a same time. If communication is performed by combining the MIMO technology with multiple frequency bands, communication rate is increased, delay is reduced and regional throughput is improved.

Methods provided by the present disclosure are based on the above wireless communication system.

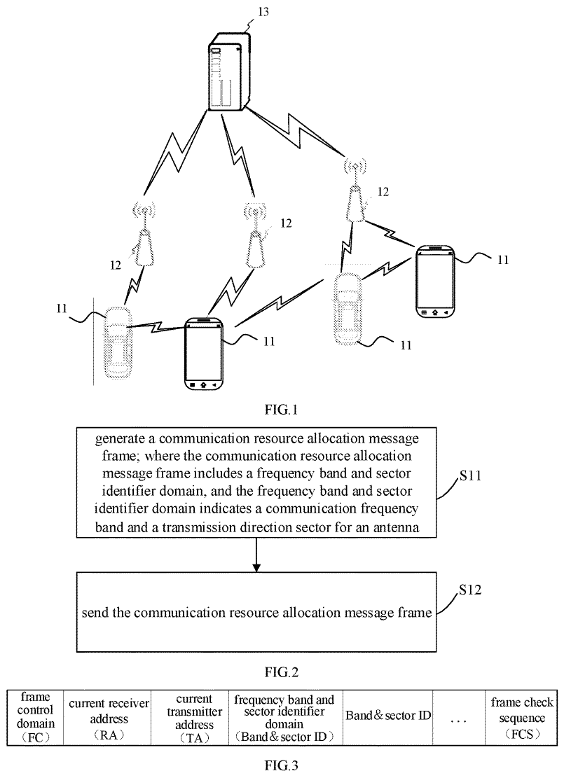

FIG. 2 is a flowchart illustrating a resource allocation method according to an embodiment of the present disclosure. As shown in FIG. 2, the resource allocation method is applied to a sender device. The method includes the following steps.

At step S11, a communication resource allocation message frame is generated; wherein the communication resource allocation message frame includes a frequency band and sector identifier domain, and the frequency band and sector identifier domain indicates a communication frequency band and a transmission direction sector for an antenna.

In an example implementation, the frequency band and sector identifier domain includes:

a first field indicating the communication frequency band;

a second field indicating the transmission direction of the antenna.

In an example implementation, when the second field is assigned a first class parameter value, the second field indicates that the transmission direction of the antenna is omnidirectional; when the second field is assigned with a second class parameter value, the second field indicates that the antenna transmits in only a portion (or sector) of the azimuthal directions corresponding to a 360° rotation about the antenna axis and indicates the particular portion or sector for transmission.

In an example implementation, for ease of descriptions, the frequency band and sector identifier domain may be denoted as Band & sector ID domain.

In an example implementation, the communication resource allocation message frame further includes a Frame Control (FC) domain, and a third field in the FC domain carries duration information of frequency band occupation.

For example, the third field is a duration field.

In an example implementation, the method further includes:

if clock frequencies of devices are synchronous in multiple frequency bands, determining a length of the third field as: a sum of a signaling length, a signaling response length, a length of data sent by one of the multiple frequency bands, a length of data confirmation reply and a length of N short inter-frame spaces (SIFS), wherein N is a positive integer equal to or greater than 3.

In an example implementation, the method further includes:

if the clock frequencies of devices are asynchronous in multiple frequency bands, determining the length of the third field as a sum of: a signaling length, a signaling response length, a length of data sent by a corresponding frequency band, a length of data confirmation reply and a length of N SIFSs, wherein N is a positive integer equal to or greater than 3.

In an example implementation, when the sender device is an access point (AP), the receiver device is a station (STA).

In an example implementation, when the sender device is an STA, the receiver device is an AP.

Therefore, before sending data at the same time under multiple frequency bands, the sender device performs multi-frequency band negotiation with the receiver device through a communication resource allocation message frame.

FIG. 3 is a schematic diagram illustrating a format of a communication resource allocation message frame. As shown in FIG. 3, the communication resource allocation message frame includes an FC domain, a current Receiver Address (RA), a current Transmitter Address (TA), multiple Band & sector ID domains and a Frame Check Sequence (FCS) domain.

The communication resource allocation message frame may be transmitted omnidirectionally or transmitted in a given azimuthal direction.

A Band field in the Band & sector ID domain is used to indicate a communication frequency band, for example, 2.4 GHz, 5.8 GHz, 6-7 GHz or the like, and a sector ID field in the Band &sector ID domain is used to represent the transmission direction of the antenna.

When the sector ID field is assigned a first class parameter value, the sector ID field indicates that the antenna transmits in all directions perpendicular to an antenna axis (azimuthal directions) wherein all azimuthal directions comprise a 360° rotation about the axis, i.e., the transmission radiation pattern is omnidirectional.

The term omnidirectional refers an antenna that transmits in all directions perpendicular to an axis (azimuthal directions) for a 360° rotation about the axis.

For example, if the sector ID is identified using three bits, when none of the three bits is assigned, it indicates the antenna transmits in all directions perpendicular to an axis (azimuthal directions) corresponding to a 360° rotation about the axis, i.e., the transmission pattern is omnidirectional.

When the sector ID field is assigned with a second class parameter value, the sector ID field indicates that the antenna transmits in only a portion (or sector) of the azimuthal directions corresponding to a 360° rotation about the axis and the ID field further indicates the particular sector in which transmission occurs.

For example, if an omnidirectional antenna transmits equally in all directions perpendicular to an antenna axis (azimuthal directions) for a 360° rotation about the axis, the azimuthal directions comprising the 360° rotation may be portioned into six 60° transmission sectors. If the sector ID is identified using three bits, “000” represents azimuthal transmission directions corresponding to a first 60° transmission sector of the 360°; “001” represents azimuthal transmission directions corresponding to a second 60° transmission sector of the 360°; “010” represents azimuthal transmission directions corresponding to a third 60° transmission sector of the 360°; “100” represents azimuthal transmission directions corresponding to a fourth 60° transmission sector of the 360°; “101” represents azimuthal transmission directions corresponding to a fifth 60° transmission sector of the 360°; “111” represents azimuthal transmission directions corresponding to a sixth 60° transmission sector of the 360°.

As shown in FIG. 3, the communication resource allocation message frame includes multiple Band & sector ID domains, where the Band field is used to represent the communication frequency band, and the sector ID field is used to represent the transmission direction of the antenna under corresponding communication frequency band. When one Band & sector ID domain is assigned, it indicates that data is sent in one communication frequency band and the specific transmission direction of the antenna is determined based on a value corresponding to the sector ID field; when two or more Band & sector ID domains are assigned, it indicates that data is sent in multiple communication frequency bands and the specific transmission direction of the antenna under each communication frequency band is determined based on a value corresponding to the sector ID field for the corresponding communication frequency band.

It should be understood that the example of a format of the communication resource allocation message frame illustrated in FIG. 3 is an optional specific implementation and is not limiting of the examples herein.

It is further understood that the example of FIG. 3 is only used to illustrate examples of embodiments of the present disclosure and those skilled in the art may perform various obvious changes and/or replacements based on the example of FIG. 3 and the technical solution obtained thereby still falls within the scope of the present disclosure.

At step S12, the communication resource allocation message frame is sent.

In this way, the sender device sends the communication resource allocation message frame to the receiver device. When receiving the communication resource allocation message frame, the receiver device may determine a communication frequency band and a transmission direction of the antenna based on the frequency band and sector identifier domain and may further establish a wireless communication link with the sender device based on the communication frequency band and the transmission direction, so as to complete negotiation between devices before data transmission.

In the technical solution provided by the embodiments of the present disclosure, a technique in which the devices perform MIMO communication at the same time under multiple frequency bands is provided and disclosed. The sender device generates a communication resource allocation message frame, and sends it to the receiver device, where the communication resource allocation message frame includes a frequency band and sector identifier domain which indicates a communication frequency band and a transmission direction of the antenna. When receiving the communication resource allocation message frame, the receiver device may determine the communication frequency band and the transmission direction of the antenna based on the frequency band and sector identifier domain and establish a wireless communication link with the sender device based on the communication frequency band and the transmission direction. In this case, before sending data at the same time under multiple frequency bands, the sender device may perform multi-frequency band negotiation with the receiver device through the communication resource allocation message frame, such that the devices perform MIMO communication at the same time under multiple frequency bands. Thus, the communication rate is increased, the delay is reduced and the throughput is improved. Further, the effective utilization rate of frequency spectrum is indirectly improved.

FIG. 4 is a flowchart illustrating a message frame processing method according to an embodiment of the present disclosure. As shown in FIG. 4, the message frame processing method is applied to a receiver device. The method includes the following steps.

At step S21, a communication resource allocation message frame is received.

At step S22, a communication frequency band and a transmission direction sector for an antenna are determined based on a frequency band and sector identifier domain included in the communication resource allocation message frame.

In this way, the receiver device may easily perform negotiation prior to data communication with a sender device through the communication resource allocation message frame.

In the above solution, the method further includes:

At step S23 (not shown in FIG. 4), a wireless communication link is established with the sender device of the communication resource allocation message frame based on the communication frequency band and the transmission direction.

In an example implementation, the communication resource allocation message frame further includes a Frame Control (FC) domain and a third field in the FC domain carries duration information of frequency band occupation; wherein the method further includes:

based on the third field in the FC domain included in the communication resource allocation message frame, determining an occupation duration of each frequency band.

In an example implementation, establishing the wireless communication link with the sender device of the communication resource allocation message frame based on the communication frequency band and the transmission direction includes:

establishing the wireless communication link with the sender device of the communication resource allocation message frame according to the occupation duration of each frequency band and the transmission direction.

In this way, the receiver device may send a scheduling signaling to schedule its communication data according to the duration and transmission direction of the data communication under each frequency band.

In the technical solution provided by the embodiments of the present disclosure, a technique by which the devices perform MIMO communication at the same time under multiple frequency bands is provided. The receiver device receives a communication resource allocation message frame from the sender device, where the communication resource allocation message frame includes a frequency band and sector identifier domain which indicates a communication frequency band and a transmission direction of the antenna. The receiver device may determine the communication frequency band and the transmission direction of the antenna based on the frequency band and sector identifier domain and establish a wireless communication link with the sender device based on the communication frequency band and the transmission direction. In this case, before sending data at the same time under multiple frequency bands, the sender device may perform multi-frequency band negotiation through the communication resource allocation message frame, such that the devices perform MIMO communication at the same time under multiple frequency bands. Thus, the communication rate is increased, the delay is reduced and the throughput is improved. Further, the effective utilization rate of frequency spectrum is indirectly improved.

FIG. 5 is a structural schematic diagram illustrating a composition of a resource allocation apparatus according to an embodiment of the present disclosure. The resource allocation apparatus is applied to a sender device side. As shown in FIG. 5, the resource allocation apparatus includes a generating unit 10 and a sending unit 20.

The generating unit 10 configured to generate a communication resource allocation message frame; wherein the communication resource allocation message frame includes a frequency band and sector identifier domain and the frequency band and sector identifier domain indicates a communication frequency band and a transmission direction of an antenna;

the sending unit 20 is configured to send the communication resource allocation message frame.

In an example implementation, the frequency band and sector identifier domain includes:

a first field indicating the communication frequency band;

a second field indicating the transmission direction of the antenna.

In an example implementation, when the second field is assigned with a first class parameter value, the second field indicates that the transmission direction of the antenna is omnidirectional; when the second field is assigned with a second class parameter value, the second field indicates that the transmission direction of the antenna is oriented and indicates the oriented direction.

In an example implementation, the communication resource allocation message frame further includes a FC domain, and a third field in the FC domain carries duration information of frequency band occupation.

In an example implementation, the generating unit 10 is further configured to determine a length of the third field in the FC domain included in the communication resource allocation message frame.

In an example implementation, the generating unit 10 is further configured to:

if clock frequencies between devices in multiple frequency bands are synchronous, determine the length of the third field as: a sum of a signaling length, a signaling response length, a length of data sent by one of the multiple frequency bands, a length of data confirmation reply and a length of N short inter-frame spaces (SIFS), wherein N is a positive integer equal to or greater than 3.

In an example implementation, the generating unit 10 is further configured to:

if the clock frequencies between devices in multiple frequency bands are asynchronous, determine the length of the third field as a sum of: a signaling length, a signaling response length, a length of data sent by a corresponding frequency band, a length of data confirmation reply and a length of N SIFSs, wherein N is a positive integer equal to or greater than 3.

The specific manners in which various modules in the apparatus of the above embodiments perform operations are already elaborated in the method-related embodiments and thus will not be repeated herein.

In a practical application, the specific structures of the above generating unit 10 and sending unit 20 may be implemented by the resource allocation apparatus or by a central processing unit (CPU), a micro controller unit (MCU), a digital signal processor (DSP) or a programmable logic controller (PLC) or the like in a device to which the resource allocation apparatus belongs.

The resource allocation apparatus in the embodiment may be disposed in the sender device such as STA or AP.

Those skilled in the art will understand that the functions of various processing modules in the resource allocation apparatus in the embodiments of the present disclosure may be understood by referring to related descriptions of the above resource allocation method applied to the sender device side, and various processing modules of the resource allocation apparatus in the embodiments of the present disclosure may be implemented by an analog circuit implementing the functions of the embodiments of the present disclosure, or by running a software executing processor-executable instructions configuring a processor comprising a unit or module to implement the functions of the embodiments of the present disclosure on a terminal.

The resource allocation apparatus according to the embodiments of the present disclosure can, before sending data under multiple frequency bands, perform multi-frequency band negotiation with the data receiver device through the communication resource allocation message frame, so that the devices perform MIMO communication at the same time under multiple frequency bands. In this way, the communication rate is increased, the delay is reduced and the throughput is improved. Further, the effective utilization rate of frequency spectrum is improved indirectly.

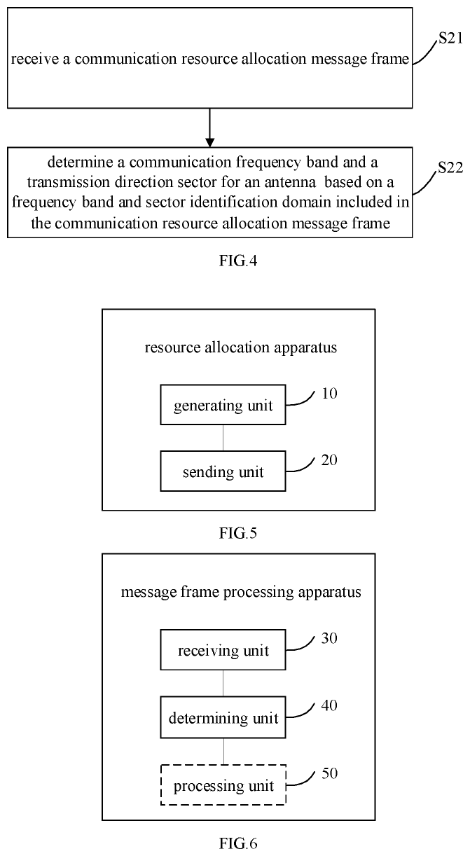

FIG. 6 is a structural schematic diagram illustrating a composition of a message frame processing apparatus according to an embodiment of the present disclosure. The message frame processing method is applied to a receiver device side. As shown in FIG. 6, the message frame processing apparatus includes a receiving unit 30 and a determining unit 40.

The receiving unit 30 is configured to receive a communication resource allocation message frame.

The determining unit 40 is configured to determine a communication frequency band and a transmission direction of an antenna based on a frequency band and sector identifier domain included in the communication resource allocation message frame.

In an example implementation, the apparatus further includes:

a processing unit 50, configured to:

based on the communication frequency band and the transmission direction, establish a wireless communication link with a sender device of the communication resource allocation message frame.

In an example implementation, the communication resource allocation message frame further includes a FC domain, and a third field in the FC domain carries duration information of frequency band occupation.

In an example implementation, the determining unit 40 is further configured to:

based on the third field in the FC domain included in the communication resource allocation message frame, determine an occupation duration of each frequency band.

In an example implementation, the processing unit 50 is further configured to:

establish the wireless communication link with the sender device of the communication resource allocation message frame according to the occupation duration of each frequency band and the transmission direction.

It is noted that if clock frequencies between devices in each frequency band is asynchronous, the occupation durations for different frequency bands will be unequal.

The specific manners in which various modules in the apparatus of the above embodiments perform operations are already described in detail above in the method-related embodiments and thus will not be repeated herein.

In a practical application, the specific structures of the above receiving unit 30 and determining unit 40 may be implemented by the message frame processing apparatus or by a CPU, MCU, DSP or PLC or the like in a device to which the message frame processing apparatus belongs.

The message frame processing apparatus in the embodiment may be disposed in the receiver device side such as STA or AP.

Those skilled in the art would understand that the functions of various processing modules in the message frame processing apparatus in the embodiments of the present disclosure can be understood by referring to related descriptions of the above message frame processing method applied to the receiver device side, and various processing modules of the message frame processing apparatus in the embodiments of the present disclosure may be implemented by an analog circuit implementing the functions of the embodiments of the present disclosure, or by running software comprising processor-executable instructions that configure a processor to perform the functions of the embodiments of the present disclosure on a terminal.

The message frame processing apparatus according to the embodiments of the present disclosure can, before sending data under multiple frequency bands, perform multi-frequency band negotiation with the sender device through the communication resource allocation message frame, so that the devices perform MIMO communication at the same time under multiple frequency bands. In this way, the communication rate is increased, the delay is reduced and the throughput is improved. Further, the effective utilization rate of frequency spectrum is improved indirectly.

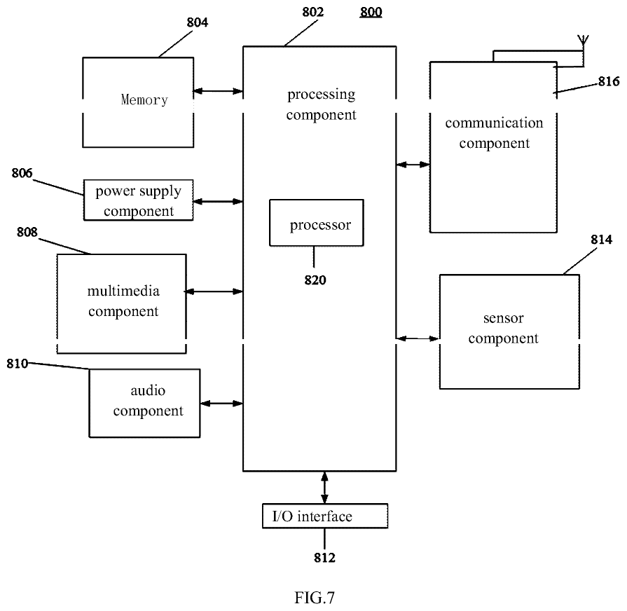

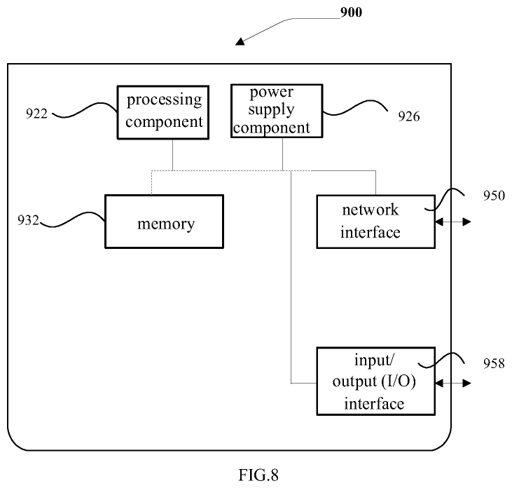

FIG. 7 is a block diagram illustrating a message frame processing apparatus 800 according to an embodiment of the present disclosure. For example, the apparatus 800 may be specifically mobile phone, computer, digital broadcast terminal, message transceiving device, game console, tablet device, medical device, fitness device and personal digital assistant and the like.

As shown in FIG. 7, the apparatus 800 may include one or more of the following components: a processing component 802, a memory 804, a power supply component 806, a multimedia component 808, an audio component 810, an input/output (I/O) interface 812, a sensor component 814 and a communication component 816.

The processing component 802 generally controls overall operations of the apparatus 800, such as operations associated with display, phone calls, data communications, camera operations, and recording operations. The processing component 802 may include one or more processors 820 to execute instructions to complete all or part of the steps of the above methods. In addition, the processing component 802 may include one or more modules which facilitate the interaction between the processing component 802 and other components. For example, the processing component 802 may include a multimedia module to facilitate the interaction between the multimedia component 808 and the processing component 802.

The memory 804 is configured to store various types of data and instructions to support the operation of the apparatus 800. Examples of these include instructions for any application or method operated on the apparatus 800, contact data, phonebook data, messages, pictures, videos, and so on. The memory 804 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or compact disk.

The power supply component 806 supplies power for different components of the apparatus 800. The power supply component 806 may include a power supply management system, one or more power supplies, and other components associated with generating, managing and distributing power for the apparatus 800.

The multimedia component 808 includes a screen that provides an output interface between the apparatus 800 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may not only sense the boundary of touch or slide actions but also detect the duration and pressure associated with touch or slide operations. In some embodiments, the multimedia component 808 includes a front camera and/or a rear camera. When the apparatus 1 800 is in an operation mode, such as a shooting mode or a video mode, the front camera and/or the rear camera may receive external multimedia data. Each of the front and rear cameras may be a fixed optical lens system or have a focal length and an optical zoom capability.

The audio component 810 is configured to output and/or input audio signals. For example, the audio component 810 includes a microphone (MIC) configured to receive an external audio signal when the apparatus 800 is in an operation mode, such as a call mode, a recording mode, and a voice recognition mode. The received audio signal may be further stored in the memory 804 or transmitted via the communication component 816. In some embodiments, the audio component 810 also includes a loudspeaker for outputting an audio signal.

The I/O interface 812 provides an interface between the processing component 802 and a peripheral interface module which may be a keyboard, a click wheel, a button, or the like. These buttons may include, but are not limited to a home button, a volume button, a start button, and a lock button.

The sensor component 814 includes one or more sensors for providing a status assessment in various aspects to the apparatus 800. For example, the sensor component 814 may detect an open/closed state of the apparatus 800, and the relative positioning of components, for example, the component is a display and a keypad of the apparatus 800. The sensor component 814 may also detect a change in position of the apparatus 800 or a component of the apparatus 800, the presence or absence of a user in contact with the apparatus 800, the orientation or acceleration/deceleration of the apparatus 800 and a change in temperature of the apparatus 800. The sensor component 814 may include a proximity sensor configured to detect the presence of nearby objects without any physical contact. The sensor component 814 may also include a light sensor, such as a Complementary Metal Oxide Semiconductor (CMOS) or Charge-coupled Device (CCD) image sensor, for use in imaging applications. In some embodiments, the sensor component 814 may also include an acceleration sensor, a gyro sensor, a magnetic sensor, a pressure sensor, or a temperature sensor.

The communication component 816 is configured to facilitate wired or wireless communication between the apparatus 800 and other devices. The apparatus 800 may access a wireless network based on a communication standard, such as WiFi, 2G or 3G, or a combination thereof. In an embodiment, the communication component 816 receives broadcast signals or broadcast associated information from an external broadcast management system via a broadcast channel. In an embodiment, the communication component 816 also includes a near field communication (NFC) module to facilitate short range communication. For example, the NFC module may be implemented based on a radio frequency identification (RFID) technology, an infrared data association (IrDA) technology, an ultrawideband (UWB) technology, a Bluetooth (BT) technology, and other technologies.

In an example, the apparatus 800 may be implemented by one or more application specific integrated circuits (ASICs), digital signal processors (DSPs), digital signal processing devices (DSPDs), programmable logic devices (PLDs), a field programmable gate array (FPGA), a controller, a microcontroller, a microprocessor or other electronic elements for performing the above message frame processing methods.

In an embodiment, there is also provided a non-transitory computer storage medium including executable instructions, such as a memory 804 including executable instructions, where the executable instructions are executable by the processor 820 of the apparatus 800 to perform the message frame processing method as described above. For example, the non-transitory computer storage medium may be Read Only memory (ROM), Random Access Memory (RAM), CD-ROM, magnetic tape, floppy disk, and optical data storage device and the like.

FIG. 8 is a block diagram illustrating a resource allocation apparatus 900 according to an embodiment of the present disclosure. For example, the apparatus 900 may be provided as a server. As shown in FIG. 8, the apparatus 900 includes a processing component 922 and further includes one or more processors and memory resources represented by a memory 932 and used to store instructions executable by the processing component 922, e.g. application program. The application program stored in the memory 932 may include one or more modules, each of which corresponds to one group of instructions. Further, the processing component 922 is configured to execute instructions to implement the above resource allocation methods.

The apparatus 900 may further include one power supply component 926 configured to perform power management of the apparatus 900, one wireless or wired network interface 950 configured to connect the apparatus 900 to a network, and one input/output (I/O) interface 958. The apparatus 900 may be operated based on an operating system stored in the memory 932, for example, Windows Server™, Mac OS X™, Unix™, Linux™, FreeBSD™ or the like.

The technical solutions provided by the embodiments of the present disclosure have the following beneficial effects.

A communication resource allocation message frame is generated, where the communication resource allocation message frame includes a frequency band and sector identifier domain which indicates a communication frequency band and a transmission direction of an antenna. In this case, before sending data at the same time under multiple frequency bands, a data sender device performs multi-frequency band negotiation with a data receiver device through the communication resource allocation message frame, such that the devices are capable of performing communication at the same time under multiple frequency bands, thus increasing a communication rate, reducing a delay and improving a throughput. Further, an effective utilization rate of the frequency spectrum is indirectly improved.

In a case of no conflicts, the technical solutions recorded in the embodiments of the present disclosure may be combined arbitrarily.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the following claims.

It is to be understood that the present disclosure is not limited to the precise structure described above and shown in the accompanying drawings, and that various modifications and changes may be made without departing from the scope thereof. The scope of the present disclosure is limited only by the appended claims.

### INDUSTRIAL APPLICABILITY

In the technical solutions provided by the embodiments of the present disclosure, the sender device sends a communication resource allocation message frame to the receiver device, where the communication resource allocation message frame includes a frequency band and sector identifier domain which indicates a communication frequency band and a transmission direction of the antenna. When receiving the communication resource allocation message frame, the receiver device may determine the communication frequency band and the transmission direction of the antenna based on the frequency band and sector identifier domain and establish a wireless communication link with the sender device based on the communication frequency band and the transmission direction. In this case, the sender device may perform multi-frequency band negotiation with the receiver device through the communication resource allocation message frame, such that the devices perform MIMO communication at the same time under multiple frequency bands. Thus, the communication rate is increased, the delay is reduced and the throughput is improved. Further, the effective utilization rate of frequency spectrum is indirectly improved.

1. A method for resource allocation, comprising:
generating a communication resource allocation message frame, wherein the communication resource allocation message frame comprises a frequency band and sector identifier domain, and the frequency band and sector identifier domain indicates a communication frequency band and a transmission direction sector for an antenna; and
sending the communication resource allocation message frame.

2. The method of claim 1, wherein the frequency band and sector identifier domain comprises:
a first field indicating the communication frequency band; and
a second field indicating the transmission direction sector for the antenna.

3. The method of claim 2, wherein,
when the second field comprises a first class parameter value, the second field indicates that the transmission direction of the antenna is omnidirectional;
when the second field comprises a second class parameter value, the second field indicates the transmission direction sector for the antenna.

4. The method of claim 1, wherein the communication resource allocation message frame further comprises a Frame Control (FC) domain, and a third field in the FC domain carries duration information of frequency band occupation.

5. The resource allocation method of claim 4, further comprising:
in response to that clock frequencies of devices are synchronous in multiple frequency bands, determining a length of the third field as a sum of a signaling length, a signaling response length, a length of data sent by one of the multiple frequency bands, a length of data confirmation reply and a length of N short inter-frame spaces (SIFS), wherein N is a positive integer equal to or greater than 3.

6. The resource allocation method of claim 4, further comprising:
in response to that clock frequencies of devices are asynchronous in multiple frequency bands, determining a length of the third field as a sum of a signaling length, a signaling response length, a length of data sent by a corresponding frequency band, a length of data confirmation reply and a length of N SIFSs, wherein N is a positive integer equal to or greater than 3.

7. A message frame processing method, comprising:
receiving a communication resource allocation message frame;
determining a communication frequency band and a transmission direction sector for an antenna based on a frequency band and sector identifier domain comprised in the communication resource allocation message frame.

8. The message frame processing method of claim 7, further comprising:
establishing a wireless communication link with a sender device of the communication resource allocation message frame, based on the communication frequency band and the transmission direction sector.

9. The message frame processing method of claim 8, wherein the communication resource allocation message frame further comprises a Frame Control (FC) domain and a third field in the FC domain carries duration information of frequency band occupation; wherein the method further comprises:
based on the third field in the FC domain comprised in the communication resource allocation message frame, determining an occupation duration of each frequency band.

10. The message frame processing method of claim 9, wherein, based on the communication frequency band and the transmission direction, establishing the wireless communication link with the sender device of the communication resource allocation message frame, comprises:
establishing the wireless communication link with the sender device of the communication resource allocation message frame, according to the occupation duration of each frequency band and the transmission direction sector.

11-20. (canceled)

21. A resource allocation apparatus, comprising:
a processor;
a memory storing instructions executable by the processor;
wherein the processor is configured to:
generate a communication resource allocation message frame, wherein the communication resource allocation message frame comprises a frequency band and sector identifier domain, and the frequency band and sector identifier domain indicates a communication frequency band and a transmission direction sector for an antenna;
send the communication resource allocation message frame.

22. A message frame processing apparatus, comprising:
a processor;
a memory storing instructions executable by the processor;
wherein the processor is configured to execute the executable instructions to implement the message frame processing method according to claim 7.

23. A computer storage medium, storing executable instructions, wherein the executable instructions are executed by a processor to implement the resource allocation method according to claim 1.

24. A computer storage medium, storing executable instructions, wherein the executable instructions are executed by a processor to implement the message frame processing method according to claim 7.

25. The apparatus of claim 21, wherein the frequency band and sector identifier domain comprises:
a first field indicating the communication frequency band; and
a second field indicating the transmission direction sector for the antenna.

26. The apparatus of claim 21, wherein,
when the second field comprises a first class parameter value, the second field indicates that the transmission direction of the antenna is omnidirectional;
when the second field comprises a second class parameter value, the second field indicates that the transmission direction sector for the antenna.

27. The apparatus of claim 21, wherein the communication resource allocation message frame further comprises a Frame Control (FC) domain, and a third field in the FC domain carries duration information of frequency band occupation.

28. The apparatus of claim 27, further comprising:
in response to that clock frequencies of devices are synchronous in multiple frequency bands, determining a length of the third field as a sum of a signaling length, a signaling response length, a length of data sent by one of the multiple frequency bands, a length of data confirmation reply and a length of N short inter-frame spaces (SIFS), wherein N is a positive integer equal to or greater than 3.

29. The apparatus of claim 27, further comprising:
in response to that clock frequencies of devices are asynchronous in multiple frequency bands, determining a length of the third field as a sum of a signaling length, a signaling response length, a length of data sent by a corresponding frequency band, a length of data confirmation reply and a length of N SIFSs, wherein N is a positive integer equal to or greater than 3.

30. The apparatus of claim 22, further comprising:
establishing a wireless communication link with a sender device of the communication resource allocation message frame, based on the communication frequency band and the transmission direction sector.
